(19) United States
(12) Patent Application Publication
(10) Pub. No.: US 2014/0327650 A1
(43) Pub. Date: Nov. 6, 2014

(54) TOUCH PANEL WHICH PROVIDES ACCURATE AND EFFICIENT TOUCH OPERATIONS

(71) Applicant: YOMORE TECHNOLOGY CO., LTD., Kaohsiung City (TW)

(72) Inventors: Jao-Ching Lin, KAOHSIUNG CITY (TW); Lin-Abel Chu, KAOHSIUNG CITY (TW); Chung-Yi Shen, KAOHSIUNG CITY (TW); Wen-Ting Lee, KAOHSIUNG CITY (TW)

(73) Assignee: YOMORE TECHNOLOGY CO., LTD., Kaohsiung City (TW)

(21) Appl. No.: 14/270,345

(22) Filed: May 5, 2014

(30) Foreign Application Priority Data
May 6, 2013 (TW) 102116088

(51) Int. Cl. G06F 3/044

(52) U.S. Cl. CPC G06F 3/044; G06F 2203/04111
USPC 345/174

(57) ABSTRACT

A capacitive touch panel includes an effective detecting region having a plurality of non-overlapping detecting sections. A main sensor is disposed in the effective detecting region. An auxiliary sensor is disposed in at least one detecting section for differentiating an actual touch coordinate from a ghost finger coordinate.

### BACKGROUND OF THE INVENTION

1. Field of the Invention

The present invention is related to a touch panel, and more particularly, to a capacitive touch panel capable of identifying actual touch coordinates and ghost finger coordinates using auxiliary sensors.

2. Description of the Prior Art

Due to easy operation, fast speed, thin appearance and intuitive control, touch panels have been widely used in various electronic devices, such as flat-panel computers, notebook computers, personal digital assistants (PDAs), mobile phones, satellite navigation systems or media players. There are three main types of touch panels: resistive, capacitive and optical. Capacitive sensing is characterized in high accuracy, multi-touch function, high durability and high resolution. A capacitive touch panel determines the time and location of touch events by detecting capacitance variations caused by electrostatic when human body (or an object) is in contact with the capacitive touch panel.

FIG. 1 is a diagram of a prior art capacitive touch panel 10. The capacitive touch panel 10 includes a plurality of sensing capacitors forming a sensing array which includes m columns of capacitor string X₁˜Xₘ in the vertical direction and n rows of capacitor string Y₁˜Yₙ in the horizontal direction. The location of touch events occurring on the touch panel 10 maybe represented by two-dimensional coordinates. For example, (X₃, Y₃) may represent a tactile input at the intersection of the third column of capacitor string X₃ and the third row of capacitor string Y₃. Assume that the capacitance of each sensing capacitor is equal to C, the overall capacitance of each column of capacitor string is equal to n*C, and the overall capacitance of each row of capacitor string is equal to m*C. When the tactile input is issued at the intersection of the third column of capacitor string X₃ and the third row of capacitor string Y₃, the overall capacitance of the third column of capacitor string X₃ detected by the capacitive touch panel 10 is equal to (n*C+ΔC1) and the overall capacitance of the third row of capacitor string Y₃ detected by the capacitive touch panel 10 is equal to (m*C+ΔC2). Therefore, the capacitive touch panel 10 is able to determine the touch coordinate (X₃, Y₃) of the tactile input.

FIG. 2 is a diagram illustrating the operation of the prior art capacitive touch panel 10 in multi-touch applications. When receiving tactile inputs at the coordinates (X₃, Y₃) and (Xₘ₋₁, Yₙ₋₁) simultaneously, the prior art capacitive touch panel 10 may detect capacitance variations of the capacitor strings X₃, Xₘ₋₁, Y₃ and Yₙ₋₁, thereby determining four tactile inputs at the coordinates (X₃, Y₃), (X₃, Yₙ₋₁), (Xₘ₋₁, Y₃) and (Xₘ₋₁, Yₙ₋₁). However, the coordinates (X₃, Yₙ₋₁) and (Xₘ₋₁, Y₃) are ghost finger coordinates instead of the actual coordinates due to tactile inputs. Therefore, the prior art capacitive touch panel 10 fails to operate efficiently in multi-touch applications since it requires extra scans for identifying the actual coordinates and the ghost finger coordinates.

### SUMMARY OF THE INVENTION

The present invention provides a touch panel which provides accurate and efficient touch operations. The touch panel includes an effective detecting region including a plurality of non-overlapping detecting sections; a main sensor disposed in the effective detecting region and comprising a plurality of sensing capacitors forming multiple columns of capacitor string in a first direction and multiple rows of capacitor string in a second direction perpendicular to the first direction; and a first auxiliary sensor disposed in a first detecting section among the plurality of non-overlapping detecting sections and comprising a plurality of first sensing lines. Each first sensing line is disposed between two corresponding sensing capacitors disposed in the first detecting section. Each first sensing line is not in contact with the two corresponding sensing capacitors disposed in the first detecting section. An area of the first detecting section is smaller than an area of the effective detecting region.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art capacitive touch panel.

FIG. 2 is a diagram illustrating the operation of the prior art capacitive touch panel in multi-touch applications.

FIGS. 3-7 are top-view diagrams of capacitive touch panels according to embodiments of the present invention.

FIGS. 8 and 9 are diagrams illustrating the structure of the capacitive touch panel according to the present invention.

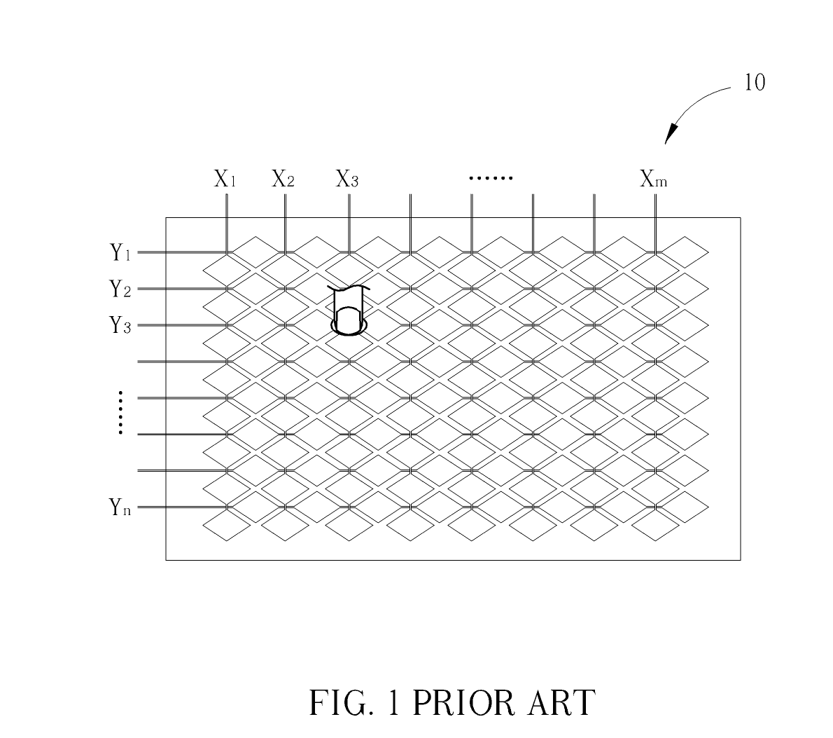

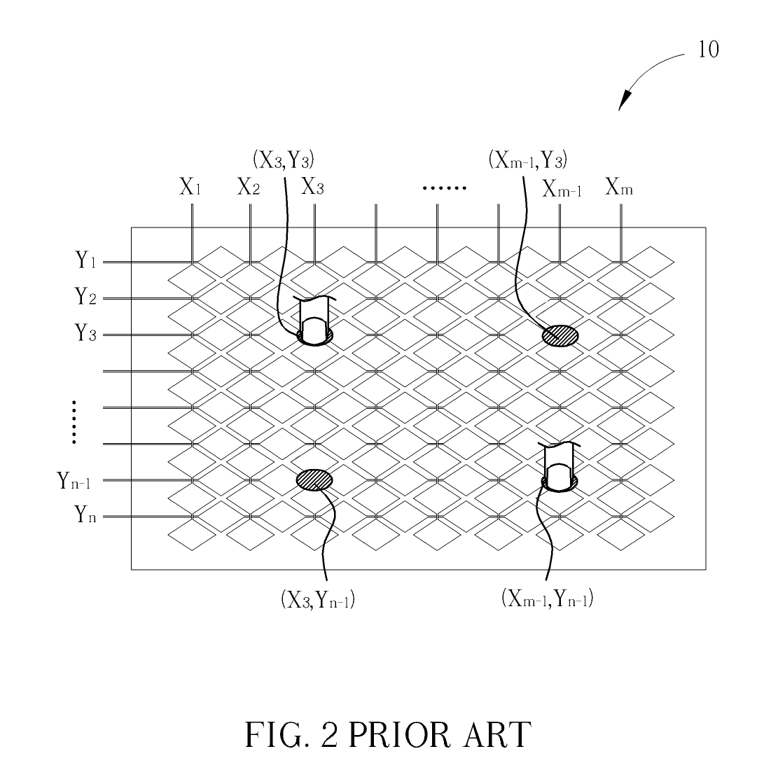

### DETAILED DESCRIPTION

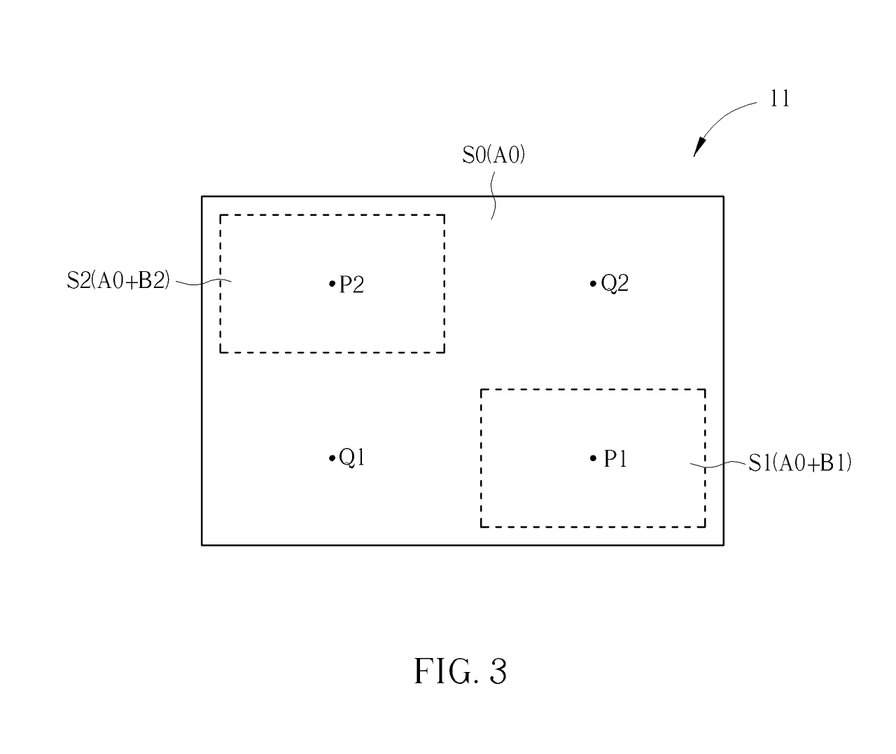

The present invention provides a capacitive touch panel which includes a main sensor and at least one auxiliary sensor configured to identify the actual coordinates and the ghost finger coordinates. FIGS. 3˜7 are top-view diagrams of capacitive touch panels 11˜15 according to embodiments of the present invention, wherein the arrangement of the main sensor and the auxiliary sensors is depicted. The effective detecting regions of the capacitive touch panels 11˜15 include a plurality of non-overlapping detecting sections S0˜Sx (x is a positive integer), wherein the detecting sections S1˜Sx are represented by dotted lines. The main sensor A0 is disposed throughout the effective detecting region (S0˜Sx), while the auxiliary sensors B1˜Bx are disposed in the detecting sections S1˜Sx, respectively. In an embodiment of x=2 as depicted in FIGS. 3˜7, only the main sensor A0 is disposed in the detecting section S0, both the main sensor A0 and the auxiliary sensor B1 are disposed in the detecting section S1, and both the main sensor A0 and the auxiliary sensor B2 are disposed in the detecting section S2. In another embodiment of the present invention, x may be an integer larger than 2 wherein both the main sensor A0 and the auxiliary sensor Bx are disposed in the detecting section Sx.

In the embodiment depicted in FIG. 3, one main sensor AO and two auxiliary sensors B1˜B2 are disposed in the capacitive touch panel 11 whose effective detecting region include three non-overlapping detecting sections S0˜S2. Each of the detecting sections S0˜S2 has an area smaller than that of the effective detecting region, and the detecting sections S1˜S2 are located at the two opposite corners of the effective detecting region. In multi-touch applications when P1 and P2 are the actual coordinates due to tactile inputs, the main sensor A0 of the capacitive touch panel 11 may detect two ghost coordinates Q1 and Q2. Since both the main sensor A0 and the auxiliary sensor B1 are disposed at P1, both the main sensor A0 and the auxiliary sensor B2 are disposed at P2, and only the main sensor A0 is disposed at Q1 and Q2, the auxiliary sensors B1 and B2 of the capacitive touch panel 11 can only detect capacitance variations at P1 and P2. Therefore, the capacitive touch panel 11 of the present invention is able to identify the ghost coordinates Q1 and Q2.

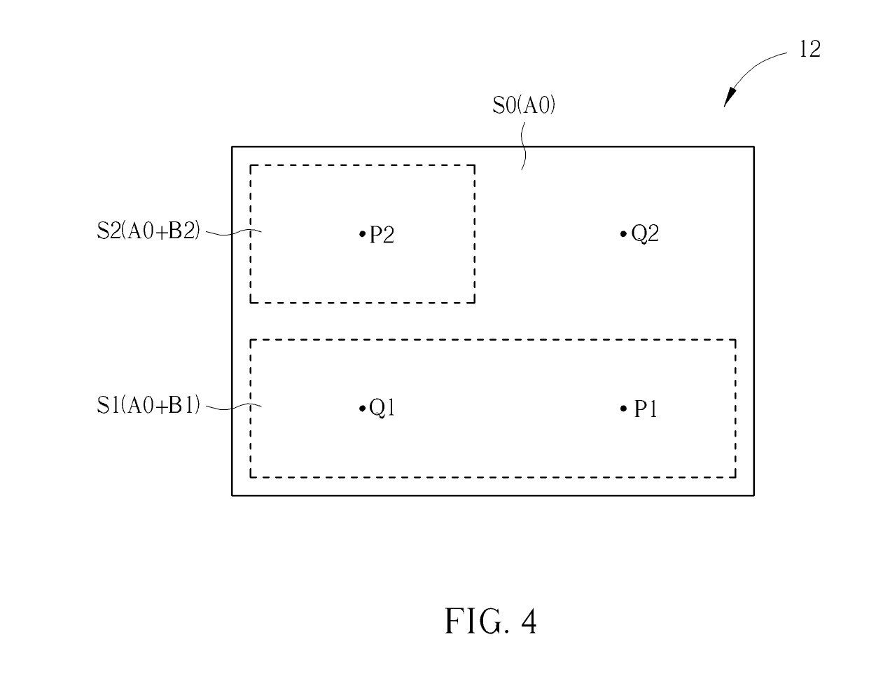

In the embodiment depicted in FIG. 4, one main sensor AO and two auxiliary sensors B1˜B2 are disposed in the capacitive touch panel 12 whose effective detecting region include three non-overlapping detecting sections S0˜S2. Each of the detecting sections S0˜S2 has an area smaller than that of the effective detecting region, and the area of the detecting sections S1 is different from the area of the detecting sections S2. The detecting sections S1˜S2 may be located at any locations within the effective detecting region. In multi-touch applications when P1 and P2 are the actual coordinates due to tactile inputs, the main sensor A0 of the capacitive touch panel 12 may detect two ghost coordinates Q1 and Q2. Since both the main sensor A0 and the auxiliary sensor B1 are disposed at P1 and Q1, both the main sensor A0 and the auxiliary sensor B2 are disposed at P2, and only the main sensor A0 is disposed at Q2, the auxiliary sensor B1 of the capacitive touch panel 12 can detect capacitance variations at P1 but none at Q1, while the auxiliary sensor B2 of the capacitive touch panel 12 can detect capacitance variations at P2. Therefore, the capacitive touch panel 12 of the present invention is able to identify the ghost coordinate Q1.

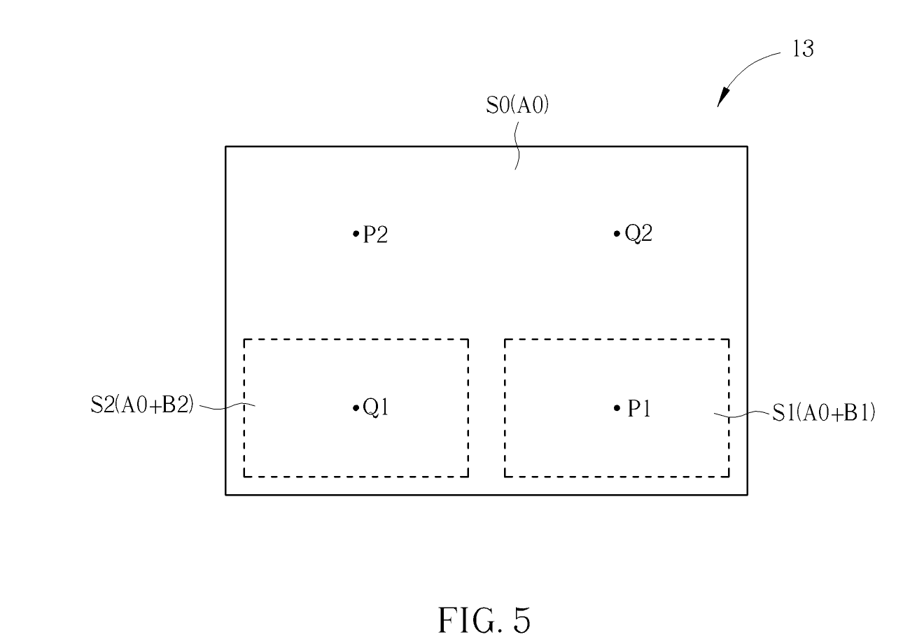

In the embodiment depicted in FIG. 5, one main sensor A0 and two auxiliary sensors B1˜B2 are disposed in the capacitive touch panel 13 whose effective detecting region include three non-overlapping detecting sections S0˜S2. Each of the detecting sections S0˜S2 has an area smaller than that of the effective detecting region, and the detecting sections S1˜S2 are located on the side of the effective detecting region, such as at the lower half. In multi-touch applications when P1 and P2 are the actual coordinates due to tactile inputs, the main sensor A0 of the capacitive touch panel 13 may detect two ghost coordinates Q1 and Q2. Since both the main sensor A0 and the auxiliary sensor B1 are disposed at P1 and both the main sensor A0 and the auxiliary sensor B2 are disposed at Q1, the auxiliary sensor B1 of the capacitive touch panel 13 can detect capacitance variations at P1, but the auxiliary sensor B2 of the capacitive touch panel 13 can not detect any capacitance variation at Q1. Therefore, the capacitive touch panel 13 of the present invention is able to identify the ghost coordinate Q1.

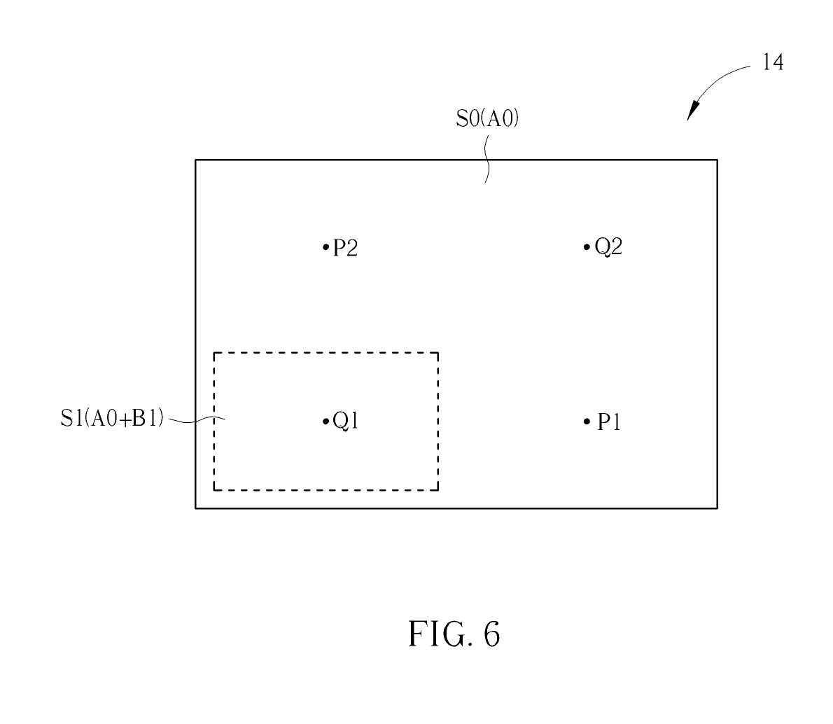

In the embodiment depicted in FIG. 6, one main sensor AO and one auxiliary sensor B1 are disposed in the capacitive touch panel 14 whose effective detecting region include two non-overlapping detecting sections S0˜S1. Each of the detecting sections S0˜S1 has an area smaller than that of the effective detecting region, and the detecting section S1 is located at one corner of the effective detecting region, such as the lower-left corner. In multi-touch applications when P1 and P2 are the actual coordinates due to tactile inputs, the main sensor A0 of the capacitive touch panel 14 may detect two ghost coordinates Q1 and Q2. Since only the main sensor AO is disposed at P1 and both the main sensor A0 and the auxiliary sensor B1 are disposed at Q1, the auxiliary sensor B1 of the capacitive touch panel 14 can not detect any capacitance variation at Q1. Therefore, the capacitive touch panel 14 of the present invention is able to identify the ghost coordinate Q1. Similarly, in multi-touch applications when Q1 and Q2 are the actual coordinates due to tactile inputs, the main sensor A0 of the capacitive touch panel 14 may detect two ghost coordinates P1 and P2. Since the auxiliary sensor B1 can only detect capacitance variations at Q1, the capacitive touch panel 14 of the present invention is able to identify the actual coordinate Q1.

The capacitive touch panels 13 and 14 may be used as touchpads of notebook computers. The positions and the areas of the detecting sections S1 and S2 in the capacitive touch panel 13 may correspond to the left button and the right button of a touchpad, respectively. The position and the area of the detecting section S1 in the capacitive touch panel 14 may correspond to the left button or the right button of a touchpad. In multi-touch applications of the touchpad which allow a user to simultaneously move his finger on the touchpad while clicking on the left button, ghost coordinates may be detected. As previously illustrated, the capacitive touch panels 13 and 14 of the present invention may identify the actual coordinates due to tactile inputs using the auxiliary sensor B1 or B2.

The operation of a physical keyboard involves various hotkey combinations with which a specific command may be issue by simultaneously pressing multiple buttons. For example, simultaneously pressing the “Ctrl” and “C” buttons allows the user to copy the selected area into the clipboard, simultaneously pressing the “Alt” and “Shift” buttons allows the user to toggle among installed keyboard languages, and simultaneously pressing the “Ctrl”, “Alt” and “Delete” buttons allows the user to reboot the notebook computer or open the file manager.

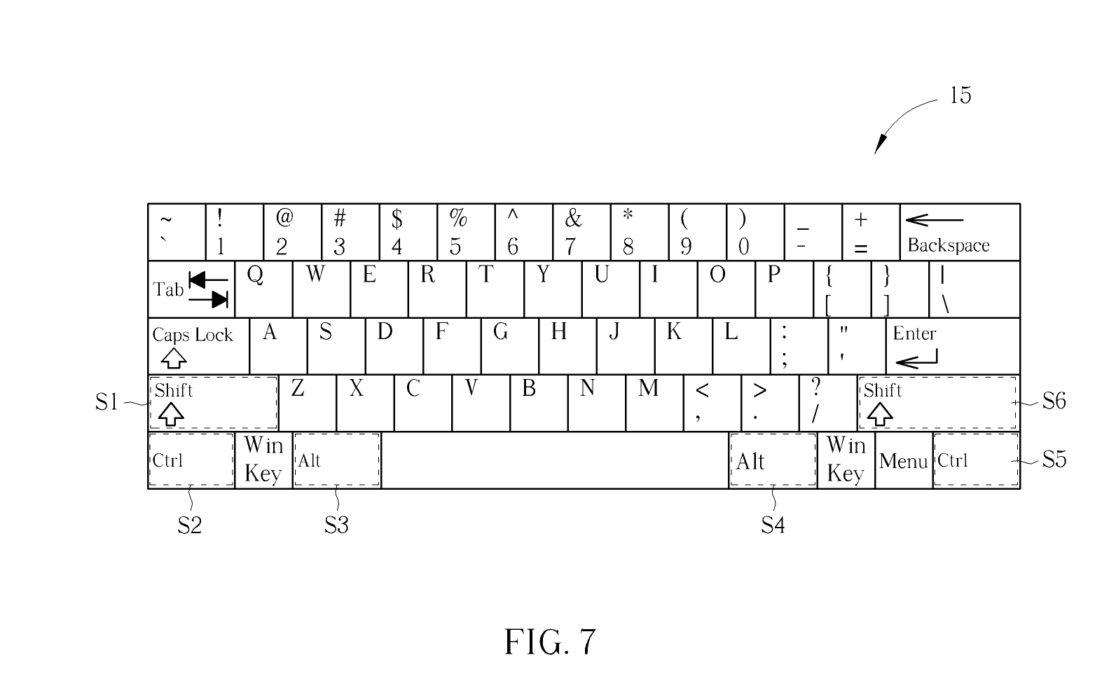

The capacitive touch panel 15 of the present invention may be applied to provide a virtual keyboard on a touch screen. As depicted in FIG. 7, the capacitive touch panel 15 is displaying a virtual keyboard in its effective sensing area, wherein the main sensor is disposed throughout the effective sensing area and multiple auxiliary sensors are disposed at detecting sections associated with frequently-used hotkey buttons. For example, six auxiliary sensors are disposed at the detecting sections S1˜S6, respectively. The positions and areas of the detecting sections S1˜S6 correspond to the “Ctrl”, “Shift” and “Alt” buttons. As previously illustrated, the capacitive touch panel 15 of the present invention may identify the actual coordinates due to tactile inputs using the auxiliary sensors disposed in the detecting sections S1˜S6, thereby providing an accurate virtual keyboard.

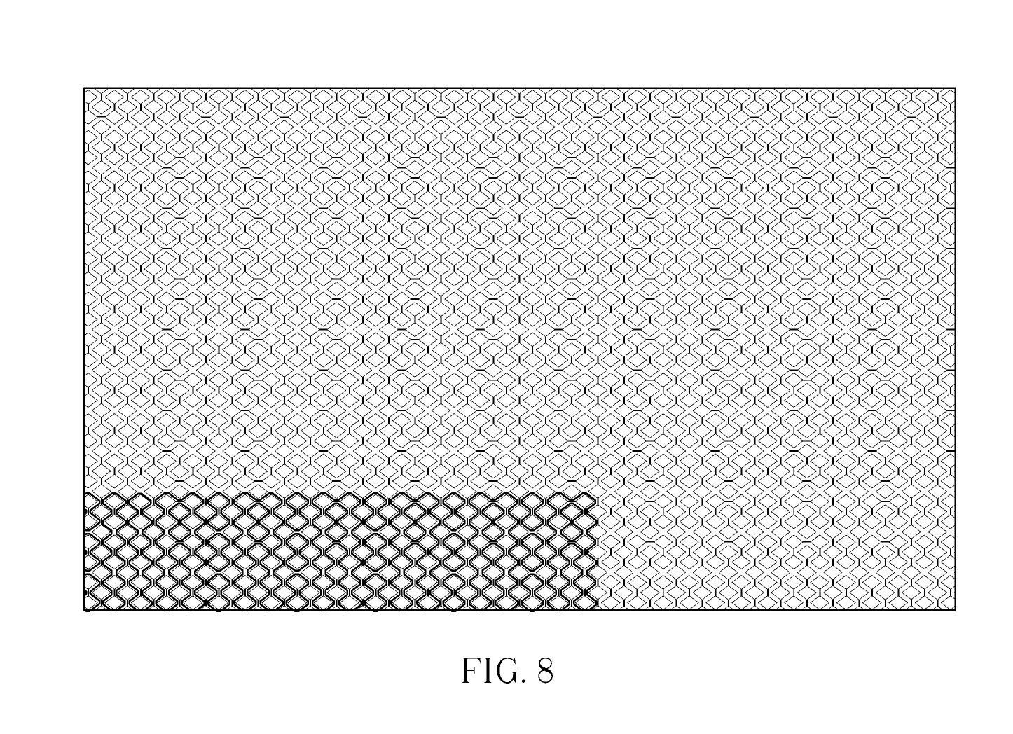

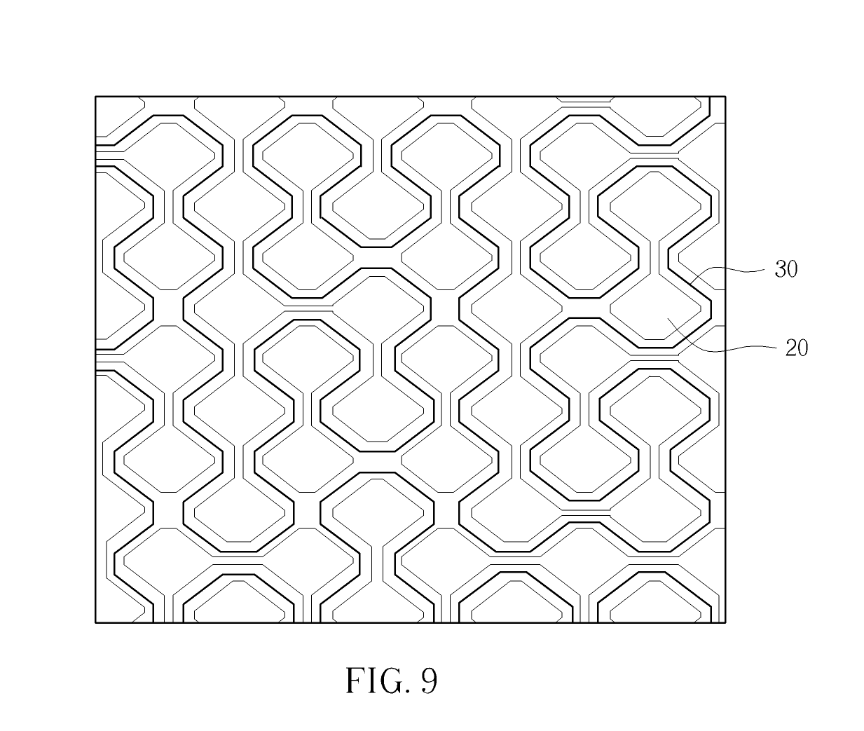

Using the embodiment depicted in FIG. 6 for illustrative purpose, FIGS. 8 and 9 are diagrams illustrating the structure of the capacitive touch panel 14 according to the present invention. FIG. 8 is a top-view diagram of the capacitive touch panel 14 which depicts the layout of the main sensor and the auxiliary sensor disposed in all detecting sections S0˜S1. FIG. 9 is an enlarged diagram of the capacitive touch panel 14 which depicts the layout of the main sensor and the auxiliary sensor disposed in the detecting section S1. The main sensor may include multiple sensing capacitors 20 forming a sensing array which includes multiple columns of capacitor string in the vertical direction and multiple rows of capacitor string in the horizontal direction, as depicted in FIGS. 8 and 9. Each sensing capacitor 20 may be equal in size. FIGS. 8 and 9 illustrate the embodiment of diamond-shaped sensing capacitors 20, but do not limit the scope of the present invention. The auxiliary sensor includes multiple sensing lines 30 disposed between corresponding sensing capacitors 20 of the main sensor. The sensing capacitors 20 are not in contact with the sensing lines 30, as depicted in FIG. 9.

In the capacitive touch panel according to the present invention, a main sensor is disposed in the effective detecting region, while one or multiple auxiliary sensors are disposed in one or multiple detecting sections within the effective detecting region according to various applications. Therefore, the present invention may identify the actual coordinates and the ghost coordinates using the one or multiple auxiliary sensors, thereby providing accurate and efficient touch operations.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel which provides accurate and efficient touch operations, comprising:
an effective detecting region including a plurality of non-overlapping detecting sections;
a main sensor disposed in the effective detecting region and comprising a plurality of sensing capacitors forming multiple columns of capacitor string in a first direction and multiple rows of capacitor string in a second direction perpendicular to the first direction; and
a first auxiliary sensor disposed in a first detecting section among the plurality of non-overlapping detecting sections and comprising a plurality of first sensing lines, wherein:
each first sensing line is disposed between two corresponding sensing capacitors disposed in the first detecting section;
each first sensing line is not in contact with the two corresponding sensing capacitors disposed in the first detecting section; and
an area of the first detecting section is smaller than an area of the effective detecting region.

2. The touch panel of claim 1, further comprising:
a second auxiliary sensor disposed in a second detecting section among the plurality of non-overlapping detecting sections and comprising a plurality of second sensing lines, wherein:
each second sensing line is disposed between two corresponding sensing capacitors disposed in the second detecting section;
each second sensing line is not in contact with the two corresponding sensing capacitors disposed in the second detecting section; and
an area of the second detecting section is smaller than an area of the effective detecting region.

3. The touch panel of claim 2, wherein the first detecting section and the second detecting section are located at two opposite corners of the effective detecting region.

4. The touch panel of claim 2, wherein the first detecting section and the second detecting section are located on a same side of the effective detecting region.

5. The touch panel of claim 2, wherein the area of the first detecting section is different from an area of the second detecting section.

6. The touch panel of claim 1, wherein the first detecting section is located at a specific corner of the effective detecting region.

7. The touch panel of claim 1, wherein:
the touch panel is a touchpad of an electronic device; and
an area and a position of the first detecting section is associated with a left button or a right button of the touchpad.

8. The touch panel of claim 1, wherein:
the touch panel is configured to display a virtual keyboard; and
an area and a position of the first detecting section is associated with a specific button of the virtual keyboard.
